(19) United States
(12) Patent Application Publication
(10) Pub. No.: US 2015/0169371 A1
(43) Pub. Date: Jun. 18, 2015

(54) PLATFORM SELF-MANAGEMENT OF RESOURCES BASED ON A CONTEXTUAL UNDERSTANDING OF USER PLANS AND GOALS

(71) Applicants: Mark D. Yarvis, Portland, OR (US); Christopher J. Lord, Portland, OR (US); Adam Elman, Sunnyvale, CA (US); Ashwin Patti, Fremont, CA (US); Anantha Deepthi Uppala, Hilsboro, OR (US); Adedamola Omotosho, San Jose, CA (US); Tea Liukkonen-Olmiala, Santa Clara, CA (US); Sweta K. Patel, Cupertino, CA (US); Milind S. Pandit, Portland, OR (US)

(72) Inventors: Mark D. Yarvis, Portland, OR (US); Christopher J. Lord, Portland, OR (US); Adam Elman, Sunnyvale, CA (US); Ashwin Patti, Fremont, CA (US); Anantha Deepthi Uppala, Hilsboro, OR (US); Adedamola Omotosho, San Jose, CA (US); Tea Liukkonen-Olmiala, Santa Clara, CA (US); Sweta K. Patel, Cupertino, CA (US); Milind S. Pandit, Portland, OR (US)

(21) Appl. No.: 14/105,676

(22) Filed: Dec. 13, 2013

(51) Int. Cl. G06F 9/50; G06F 9/48; G06Q 10/10

(52) U.S. Cl. CPC G06F 9/5005; G06Q 10/1093; G06F 9/4881

(57) ABSTRACT

Methods and systems may provide for generating an activity plan for a user of a platform and generating a resource plan based on the activity plan and a current state of the platform. Additionally, one or more conflicts between the activity plan and the resource plan may be resolved. In one example, generating the activity plan includes predicting one or more of a meeting, a trip, a presentation, a media consumption session or an application usage.

### BACKGROUND

1. Technical Field

Embodiments generally relate to computing platform management. More particularly, embodiments relate to the platform self-management of resources based on a contextual understanding of user plans and goals.

2. Discussion

Conventionally, users of computing platforms may manually manage the resources of the platform. For example, a battery life warning might notify a user when a mobile computing platform is nearly out of battery power. Such a warning may occur at an inopportune time such as, for example, just before a meeting or a flight if the user has not appropriately planned ahead. As a result, the user may be forced to either search for an outlet and a power cord in inconvenient settings and may generally have a negative user experience with regard to the platform. While manually planning ahead may be a solution, such an approach may become more challenging as computing platforms increase in complexity, particularly for multiple platform resources and individuals having busy schedules.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a platform self-management scheme according to an embodiment;

FIG. 2 is a block diagram of an example of a logic architecture according to an embodiment;

FIG. 3 is a flowchart of an example of a method of managing platform resources according to an embodiment;

FIG. 4 is a flowchart of an example of a method of resolving conflicts between an activity plan and a resource plan according to an embodiment; and

FIG. 5 is a block diagram of an example of a computing platform according to an embodiment.

### DETAILED DESCRIPTION

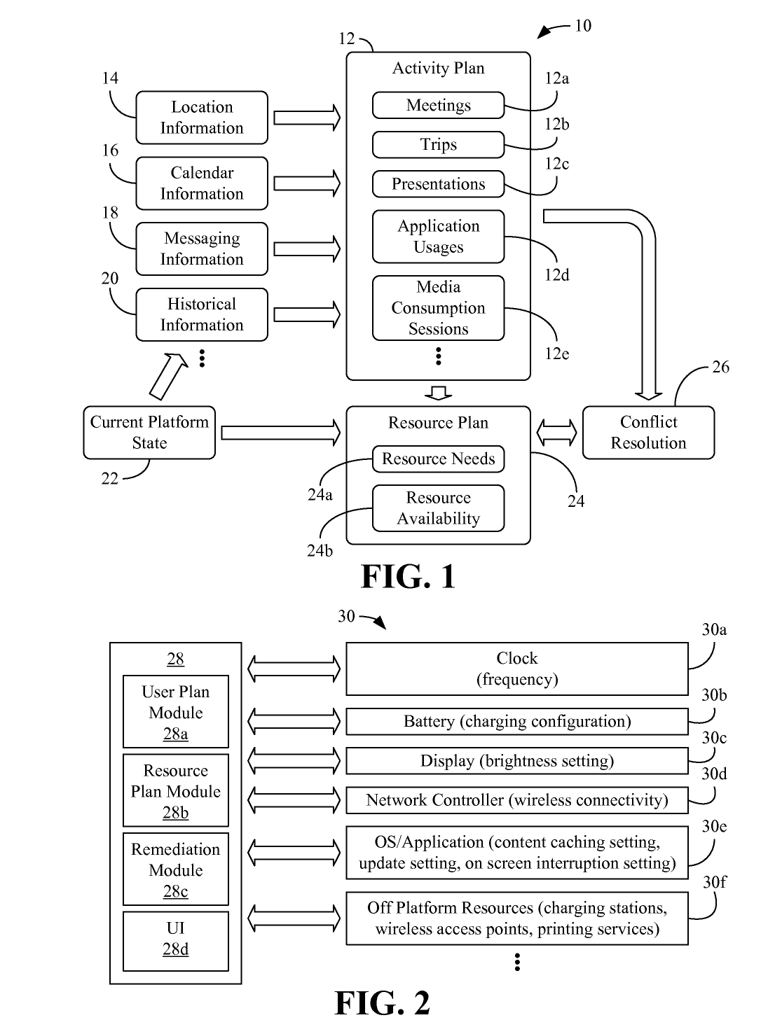

FIG. 1 shows a platform self-management scheme 10 in which an activity plan 12 (12a-12e) is generated for a user of a computing platform (not shown) such as, for example, a media player, smart phone, mobile Internet device (MID), personal digital assistant (PDA), tablet computer, convertible tablet (e.g., ULTRABOOK), notebook computer, desktop computer, workstation, wearable device, and so forth. In the illustrated example, the activity plan 12 includes meetings 12a, trips 12b, presentations 12c, application usages 12d, media consumption sessions 12e, and so forth, associated with the user and/or platform. As will be discussed in greater detail, the activity plan 12 may enable the development of a contextual understanding of the user's plans and/or goals, wherein that contextual understanding may in turn enable intelligent management of the underlying resources of the platform to meet the user's predicted needs and goals.

For example, the meetings 12a may include one or more appointments that the user is expected to attend with (e.g., while carrying and/or operating) the computing platform, the trips 12b may include one or more flights, vacations, etc., that the user is expected to take with the computing platform and the presentations 12c may include one or more seminars, workshops, courses, etc., that the user is expected to give and/or attend with the computing platform. In addition, the application usages 12d may include one or more messaging applications, video conferencing applications, browsers, word processing applications, spreadsheet applications, etc., that the user is expected to use with the computing platform, the media consumption sessions 12e may include one or more movie viewing sessions, audio listening sessions, etc., in which the user is expected to participate with the computing platform, and so forth. The predicted activities may occur in the present and/or future.

Thus, the activity plan 12 may be a set of things that the user intends to use (presumably with their device/platform) in the future and the timeframe may be relatively flexible. For example, the timeframe may be through the rest of the day, rather than specifically over the next three hours. The timeframe may typically be, however, within the scope of resource consumption. For example, the timeframe might be within the discharge of a given battery, which is likely to be between part of a day and a relatively small number of days. Simply put, the activity plan 12 may predict the user's plans and goals for the near future or over the course of the day.

The activity plan 12 may be automatically generated based on a wide variety of information such as, for example, location information 14, calendar information 16, messaging information 18, historical information 20, etc., associated with the user and/or platform. For example, the location information 14 might be obtained from one or more sensors (e.g., global positioning system/GPS, wireless networking, near field communication/NFC sensors) on the platform, wherein the location information 14 could include coordinates, addresses, cities, states, etc., corresponding to the platform's physical location. The location information 14 could also include logical location information, such as “grocery store” or “home.” The calendar information 16 may be obtained from one or more scheduling applications (e.g., MICROSOFT OUTLOOK, GOOGLE CALENDAR, APPLE ICAL, etc.) executing on the platform or on a remote server (e.g., cloud based). The calendar information 16 may therefore include dates, times, locations, subjects, agendas, attendees, etc., for meetings and/or appointments that the user has attended in the past and/or is expected to attend in the future.

The messaging information 18 may be obtained from one or more email messages, instant messages, text messages, social networking messages (e.g., wall posts, direct messages, chat messages), etc., between the user and other individuals and/or groups. The historical information 20 may include information regarding when and how the user typically interacts with the platform. For example, the historical information 20 might indicate whether the user typically charges the platform during lunch or overnight, reads email in the morning, watches videos at night, or watches movies, reads or generates presentation slides on a flight. The historical information 20 may also include information regarding the resources of the platform itself. For example, the historical information 20 might indicate past clock frequencies, battery charge states, battery discharge rates, power and/or sleep states, display brightness settings, wireless connectivity (e.g., access points, cellular network) states, operating system (OS) update settings, content caching settings, and so forth.

The illustrated self-management scheme 10 also takes into consideration a current platform state 22, which state might include information regarding current clock frequency, battery status (e.g., percent total), battery charge or discharge rates, platform power source (AC or battery), central processing unit/CPU, graphics processor/GP, memory power usage, display brightness settings, wireless connectivity (e.g., access points, cellular network) states, other sensors (e.g., ambient light sensor, accelerometer/gyroscope), and so forth. In one example, the current platform state 22 is used to populate the historical information 20. Accordingly, the activity plan 12 may automatically provide a comprehensive contextual understanding of the user's plans and goals.

In addition, a resource plan 24 (24a, 24b) may be automatically generated based on the activity plan 12 and the current platform state 22, wherein a resolution 26 for one or more conflicts between the activity plan 12 and the resource plan 24 may also be automatically generated. As will be discussed in greater detail, the conflict resolution 26 may involve any change that enables the platform to better meet the needs of the user. More particularly, the illustrated resource plan 24 identifies one or more resource needs 24a of the platform and the availability 24b of one or more resources on the platform and/or external to the platform. For example, it might be determined from the activity plan 12 that the user has four hours of meetings starting in thirty minutes and from the current platform state 22 that the current battery charge is at 50%. In such a case, the resource needs 24a of the resource plan 24 might indicate the need for enough battery life to use the platform for all of the upcoming meetings. If a conflict exists between the activity plan 12 and the resource plan 24 (e.g., there is insufficient battery life to last through the meetings), the resource availability 24b of the resource plan 24 may be used to determine that there are power outlets available at the current location and in the conference room where the meetings will be held. Accordingly, the conflict resolution 26 in such a scenario may involve prompting the user to charge the platform for the next thirty minutes and bring a power adapter to the meetings.

In another example, it may be determined from the activity plan 12 that the user has recently started watching a three hour long movie (e.g., a media consumption session) and from the current platform state 22 that the current battery charge is at 40% with a display brightness setting of 80%. In such a case, the resource needs 24a of the resource plan 24 may indicate the need for enough battery life to watch the entire movie. If a conflict exists between the activity plan 12 and the resource plan 24 (e.g., there is insufficient battery life to last through the entire movie at the current display brightness level), the resource availability 24b of the resource plan 24 might be used to determine that the brightness level is adjustable and identify known brightness/power curves (e.g., relationships). Accordingly, the conflict resolution 26 could involve prompting the user to reduce the display brightness level to, for example, 60% or select shorter content (e.g., thirty minute sitcom) to view. The conflict resolution 26 may also automatically adjust the display brightness level if the platform and/or user permit such an automatic adjustment.

A wide variety of other scenarios may benefit from the illustrated approach, as shown below in the examples of Table I. The specific values provided are to facilitate discussion only.

TABLE I

| | Activity | Platform | Resource | | Resource | Conflict |
|---|---|---|---|---|---|---|
| Resource | plan | Context | Needs | Conflict | Availability | Resolution |
| Battery | Meetings | 50% | Enough | Insufficient | Power | User |
| | in 15 min., | battery | battery | battery for | available at | prompt: |
| | for | remaining | for | meetings | current | Plug-in |
| | 4 hours | | meetings | | location; | for next |
| | | | | | power | 15 minutes |
| | | | | | available in | and/or |
| | | | | | conference | bring |
| | | | | | room. | power |
| | | | | | | adapter to |
| | | | | | | meetings |
| Display | User just | 40% | Enough | Insufficient | Adjustable | User |
| brightness | started | battery | battery to | battery for | brightness; | prompt: |
| | watching | rem.; | watch | the | known | Turn |
| | a 3 hour | screen at | entire | selected | display- | brightness |
| | movie | 80% | movie | movie | power | to 60% or |
| | | brightness | | | curves | select |
| | | | | | | shorter |
| | | | | | | content |
| Clock | User | No AC | Minimize | Power cost | Known | Select |
| freq. | currently | power; | power | of | clock | lower |
| | reading | running | cost of | transcode | frequency- | clock |
| | email | backgrnd. | transcode | is too high | power | frequency |
| | | transcode | while | | curves | |
| | | | user is | | | |
| | | | reading | | | |
| | | | email | | | |
| Platform | User is | Platform | Maximize | S3 sleep | Known | Transition |
| power | about to | lid is | battery | state does | sleep state- | platform |
| state | leave for | closing | life | not | power | directly to |
| | a long trip | | | maximize | curves | S4 state |
| | | | | battery life | | rather than |
| | | | | | | S3=>S4 |
| Wireless | User is at | No | Deliver | No | 3G network | User |
| conn. | a cafe; | wireless | email in | wireless | connection; | prompt: |
| | expected | access | the | access | map of | Pay for |
| | to be in | points in | outbox | points for | public | 3G data |
| | the office | range; | | email | hotspots | usage, go |
| | in 2 hours. | email in | | | | down the |
| | | outbox | | | | street to |
| | | | | | | hotspot, or |
| | | | | | | wait until |
| | | | | | | back at the |
| | | | | | | office to |
| | | | | | | deliver |
| | | | | | | email |
| Content | User has | No media | 2-3 | No movies | Movies | Auto |
| caching | a 4 hour | cached | movies | for the | stored on | cache |
| | flight this | | for the | user's | home | moves |
| | afternoon; | | user to | flight | computer; | from |
| | typical | | choose | | can copy | home PC |
| | activity: | | from | | while | |
| | watch a | | during the | | platform is | |
| | movie | | flight | | connected | |
| | | | | | to the | |
| | | | | | Internet | |
| Onscreen | User is | 10% | Enough | Screen | Opportunity | Suppress |
| interrupt. | giving a | battery | battery | blanking | to charge | screen |
| | pres.; | remaining; | for pres. | and battery | immed. | blanking |
| | 10 minutes | screen | and | warnings | after pres. | and |
| | remaining | blanking | minimize | will | | battery |
| | | and | onscreen | interrupt | | warnings; |
| | | battery | interrupt. | pres. | | after |
| | | warnings | | | | present., |
| | | enabled | | | | prompt |
| | | | | | | user to |
| | | | | | | plug into |
| | | | | | | AC |
| OS | User is | OS-App. | Minimize | Updates | Updates | Auto |
| updates | giving a | updates | interrupts | will | can be | reschedule |
| | pres. for | scheduled | during | interrupt | deferred | OS-App. |
| | next 2 hours; | during | pres. | pres. | | updates to |
| | lunch | pres. | | | | user's |
| | typically | | | | | lunch |
| | taken at | | | | | break |
| | noon | | | | | |

Turning now to FIG. 2, a logic architecture 28 (28a-28d) to manage one or more platform resources 30 (30a-30f) is shown. The resources 30 may include, for example, a clock 30a to provide timing information to the platform, a battery 30b to supply power to the platform, a display 30c to present information, a network controller 30d to connect the platform to a wireless network such as, for example, a WiFi network (Wireless Fidelity network, e.g., Institute of Electrical and Electronics Engineers/IEEE 802.11-2007, Wireless Local Area Network/LAN Medium Access Control (MAC) and Physical Layer (PHY) Specifications), an OS/application 30e to operate one or more functions of the platform, one or more off platform resources 30f (e.g., power outlets, WiFi access points, printing services, etc.), and so forth. Other components such as power management (PM) components (not shown) that establish power and/or sleep states for the platform or its devices may also be included in the resources 30.

Additionally, various parameters and/or attributes of the resources 30 may also be considered resources of the platform. For example, the frequency of the clock 30a, the charging configuration (e.g., alternating current/AC, direct current/DC) of the battery 30b, the brightness (e.g., backlight, pixel) setting of the display 30c, the wireless connectivity of the network controller 30d, content caching settings, onscreen interruption settings and/or update settings of the OS/application 30e, etc., power and/or sleep states such as, for example, Advanced Configuration and Power Interface (e.g., ACPI Specification, Rev. 5.0a, Dec. 6, 2011) states, may all be considered resources that can be used to meet the needs of the activity plan and/or resolve conflicts as described herein.

In the illustrated example, the architecture 28 includes a user plan module 28a to generate an activity plan such as, for example, the activity plan 12 (FIG. 1), for a user of the platform, wherein the user plan module 28a may predict one or more of a meeting, a trip, a presentation, a media consumption session, an application usage, and so forth, in order to generate the activity plan. Moreover, the activity plan may be generated based on one or more of location information, calendar information, historical information, message information, and so forth, associated with the user and/or platform. The architecture 28 may also include a resource plan module 28b to generate a resource plan such as, for example, the resource plan 24 (FIG. 1), based on the activity plan, a current state of the platform and external resource information (e.g., availability of power in a given location, locations of available WiFi, availability of nearby printing services, etc.). Available printing services might include, for example, FEDEX/KINKOS locations, libraries with public printers, the user's home and office. etc. The resource plan module 28b may determine one or more resource needs of the platform and an availability of one or more of the resources 30 in order to generate the resource plan.

The illustrated architecture 28 also includes a remediation module 28c to resolve one or more conflicts between the activity plan and the resource plan. For example, the remediation module 28c may automatically implement one or more platform changes, employ a user interface (UI) 28d to suggest one or more environmental changes to the user, or any combination thereof, in order to generate a conflict resolution such as, for example, the resolution 26 (FIG. 1). The platform changes may include, for example, a charging configuration switch, a display brightness setting modification, a clock frequency setting modification, a wireless connectivity switch, a onscreen interruption setting modification, an update setting modification, a sleep state transition, a content caching setting modification, etc., or any combination thereof.

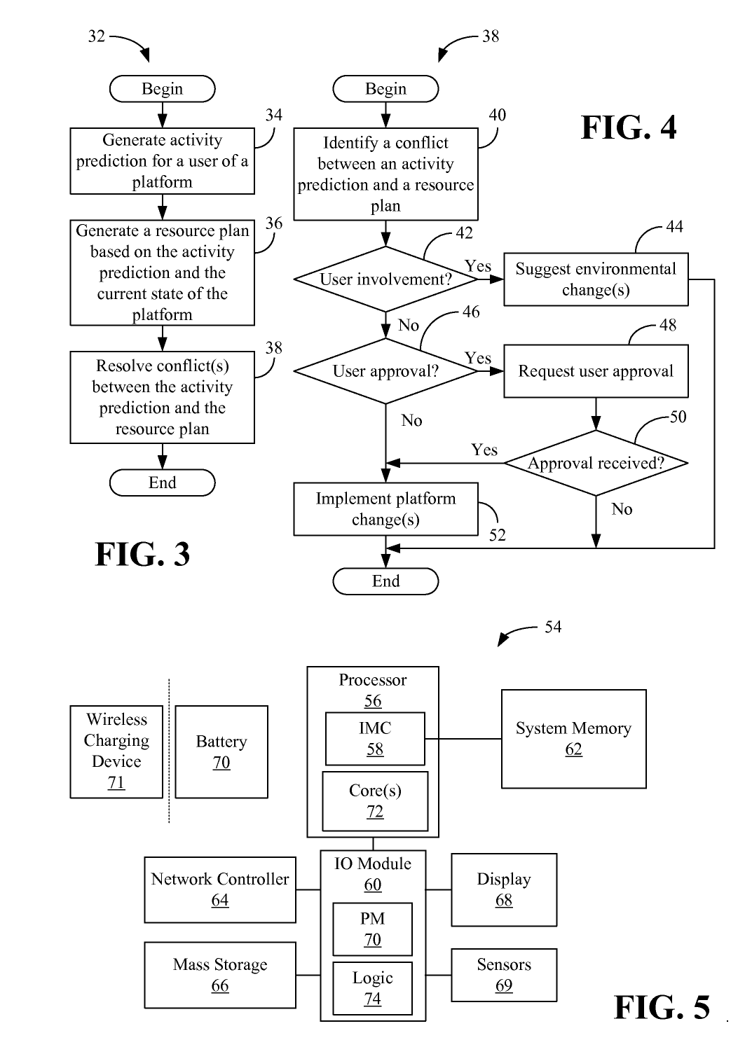

FIG. 3 shows a method 32 of managing platform resources. The method 32 may be implemented via a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Illustrated processing block 34 provides for generating an activity plan for a user of a platform, wherein a resource plan may be generated at block 36 based on the activity plan and a current state of the platform. As already noted, the activity plan may be generated based on location information, calendar information, historical information, message information, etc., and may include meetings, trips, presentations, media consumption sessions, application usages, etc. Moreover, generating the resource plan may include determining one or more resource needs of the platform and an availability of one or more resources on or off the platform. Illustrated block 38 resolves one or more conflicts between the activity plan and the resource plan.

FIG. 4 shows one approach to resolving conflicts. In the illustrated example, a conflict between an activity plan and a resource plan is identified at block 40. A determination may be made at block 42 as to whether user involvement is required to implement a resolution for the conflict. If so, illustrated block 44 suggests one or more environmental changes to the user. Block 44 may therefore involve, for example, prompting the user to plug the platform into a power outlet for a short period of time so that the platform can make it through upcoming meetings (e.g., a charging configuration switch). Accordingly, the environmental changes may be resolution options that include modifications to the external environment and impact the platform (e.g., plugging into a power source, moving to where a power outlet is available, moving to where WiFi is available. In another example, block 44 might include providing the user with the email sending options of: walking to a nearby wireless hotspot/access point, using a cellular network for data connectivity, waiting until the user returns to work, and so forth (e.g., a wireless connectivity switch).

If, on the other hand, no user involvement is required, a determination may be made at block 46 as to whether user approval of a platform change is needed. If so, illustrated block 48 requests user approval for the platform change via a user interface such as, for example, the UI 28d (FIG. 2). If it is determined at block 50 that the user has approved the platform change or at block 46 that user approval is not necessary, illustrated block 52 provides for implementing the platform change, which may include, for example, display brightness setting modifications, clock frequency setting modifications, onscreen interruption setting modifications, update setting modifications, sleep state transitions, content caching setting modifications, and so forth. Of particular note is that the path through blocks 42 and 46 to block 52 may represent an entirely automatic conflict resolution that may significantly enhance the user experience with regard to resource management on a platform.

Turning now to FIG. 5, a computing platform 54 is shown. The platform 54 may be part of a device having computing functionality (e.g., PDA, notebook computer, tablet computer, convertible tablet, desktop computer, wearable computer), communications functionality (e.g., wireless smart phone), imaging functionality, media playing functionality (e.g., smart television/TV), wearable functionality (e.g., watch, clothing) or any combination thereof (e.g., mobile Internet device/MID). In the illustrated example, the platform 54 includes a processor 56, an integrated memory controller (IMC) 58, an input output (IO) module 60, system memory 62, a network controller 64, mass storage 66 (e.g., optical disk, hard disk drive/HDD, flash memory), a display 68 to present information, a battery 70 to supply power to the platform 56, a wireless charging device 71 (e.g., resonator) to charge the battery 70, and one or more sensors 69 (e.g., ambient light sensor, accelerometer, gyroscope). The processor 56 may operate based on timing information from a clock such as, for example, the clock 30a (FIG. 2) and may include a core region with one or several processor cores 72.

The illustrated IO module 60, sometimes referred to as a Southbridge or South Complex of a chipset, functions as a host controller and communicates with the network controller 64, which could provide off-platform communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), WiFi, 4G LTE (Fourth Generation Long Term Evolution), Bluetooth, WiMax (e.g., IEEE 802.16-2004, LAN/MAN Broadband Wireless LANS), Global Positioning System (GPS), spread spectrum (e.g., 900 MHz), and other radio frequency (RF) telephony purposes. Other standards and/or technologies may also be implemented in the network controller 64. The IO module 60 may also include one or more wireless hardware circuit blocks to support such functionality. In addition, the illustrated IO module 60 has a power management (PM) component 75 to establish various power and/or sleep state transitions for the platform 54 and/or its devices. Although the processor 56 and IO module 60 are illustrated as separate blocks, the processor 56 and IO module 60 may be implemented as a system on chip (SoC) on the same semiconductor die.

The system memory 62 may include, for example, double data rate (DDR) synchronous dynamic random access memory (SDRAM, e.g., DDR3 SDRAM JEDEC Standard JESD79-3C, April 2008) modules. The modules of the system memory 62 may be incorporated into a single inline memory module (SIMM), dual inline memory module (DIMM), small outline DIMM (SODIMM), and so forth. The system memory 62, the mass storage 66, one or more internal caches (not shown) of the processor 56, etc., or any combination thereof, may be used to cache media content as described herein.

The illustrated IO module 60 includes logic 74 to generate activity plans for users of the platform 54, generate resource plans based on the activity plans and the current state of the platform, and resolve one or more conflicts between the activity plans and the resource plans. The logic 74 may therefore function similarly to the logic architecture 28 (FIG. 2), already discussed.

Example Scenarios

The below scenarios describe a contextually-aware platform that manages itself over the course of the day. The platform may predict the user's plans and goals, learn preferred platform settings and continuously prepare and manage resources to achieve the users' needs. In general, the platform may look into the future to predict platform requirements and resources given the expected environment and offer remediation steps when situations are difficult or won't meet the user's plans.

The scenarios describe a theoretical individual, “Shannon”, who is a pharmaceutical rep in the Great Lakes region of the United States, and is married with two children. She often visits several hospitals and doctor's offices over the course of a workday. Shannon's employer requires her to be cognizant of product releases, regulatory documentation, research results, and product inventory. They provide her with product collateral, mobile apps and web-based training tools.

Platform Predicts User Plans and Caches Content Shannon starts her day, walks into the kitchen, picks up her laptop, and launches her email reader. Shannon's manager sent email requesting her feedback on two product training videos by the end of the day. Shannon has a round-trip one-hour flight for a product presentation on her calendar today. Shannon's daughter has a soccer coach who posted new updates to the team's webpage along with highlights from the last game to YOUTUBE. In this example, the platform determines that it has local storage space available; it caches the two training videos and the YOUTUBE content. The platform may therefore predict the user's platform needs based on various sources such as calendar, email, tasks, and historical information, then identify and cache needed content. If the platform has a large amount of storage space (e.g. solid state disk/SSD>500 GB), it may intelligently manage the content based on the user's prior usage models.

Watching Video

While in the car on the way to school Shannon and the kids like to listen to sing-along songs. She plugs her phone audio out into the car's auxiliary audio jack and turns the phone volume up to the maximum level. She then adjusts the audio volume using her car's amplifier. After dropping the kids at school, Shannon stops by the local coffee shop, connects to her corporate network and starts the thirty minute product training video (the other video is one hour long). She is sitting in a brightly-lit window area. In this example, her device has learned Shannon's preferred screen brightness given environmental inputs such as ambient lighting conditions, current application(s), and selected screen brightness. Even though the platform is using battery power, in this example, the platform does immediately dim the backlight and instead uses Shannon's preferred settings. When Shannon has finished her training video, she plugged her earphones into the phone. In this example, the phone automatically adjusts the volume from maximum to a level based on Shannon's prior usage, given the location change, type of audio media, and ambient background noise. The platform may therefore learn preferred device settings such as screen brightness given environmental factors such as ambient light and foreground applications.

Lack of WiFi with Urgent Outbound Email Message

While watching the training video, the WiFi connection at the coffee shop drops. Nonetheless, Shannon completes the thirty minute training video (because the content was cached), and sends her manager a reply that she has completed the first video training. The (non-time-critical) email sits in her outbox due to a lack of WiFi.

She then receives an instant message from her neighbor who was going to pick up their kids at daycare, that she can't make it today. Shannon sends a text to her husband to rearrange his day to pick up the kids before 6:30. Her husband had planned to attend a soccer game starting at 6:30, and now he cannot attend. Shannon has e-tickets for the game and wants to forward the e-tickets to her friend for tonight's game. She sends the email but there is still no WiFi access. Noticing an important time-critical email message pending in her outbox, in this example, her laptop offers her suggestions: She can wait until later in the day when she'll be at the airport with WiFi access, walk over to a nearby library, or pair her laptop and phone and send it. She decides to walk over to the library. At the library, the platform may send both email messages. The platform cached the training videos listed in her manager's email so the video completed even though WiFi had disconnected. The platform may therefore provide remediation steps for urgent WiFi access by offering the user varying options based on convenience, cost, and timeliness.

Printing a Document

While at the library, Shannon realizes that she has had a pending regulatory document to be signed by a client she will visit that afternoon. Shannon opens her laptop, loads the document, enters the pertinent client information and selects print. There are public printers; however her laptop does not have the correct network and printer drivers installed. In this example, her laptop offers her suggestions to print: She can go back home to print or use web-based services at the nearby Kinko's to print or she can use her phone as an intermediary between the laptop and the printer (i.e., “NFC file transfer”). Shannon taps her phone to the laptop and then places it on the printer. The laptop and printer pair via NFC, exchange driver information and print the file. The platforms may therefore provide remediation for printing devices/services, wherein the user's cross-device platforms cooperate to achieve user's goals.

Wireless Power Sharing

Shannon starts driving to the airport in the car with her phone and laptop in her carry-on bag. In this example, the phone, given prior knowledge of usage, determines that a navigation application will likely be used after landing to provide voice prompts and traffic warnings to get to the doctor's office. While still on her way to the local airport, the phone and laptop discover that the laptop is a wireless charging source and that the phone is a wireless charging sink. In this example, the laptop predicts its future battery resources for the day and its ability to request charging for the day, and determines that it can offer to wirelessly charge the phone. Accordingly, the phone charges from the laptop in this scenario. The phone may not need to completely charge. Instead, based on the amount of charge that the phone will need to provide navigation and the amount of charge the laptop will need for its future power needs, the two devices may negotiate an appropriate amount of power to transfer to the phone. Platforms may therefore cooperate to share critical resources based on a cross-device resource usage model.

During Flight

Shannon arrives at the airport and boards the flight. There is neither WiFi access nor access to a charging station. Shannon completes the one-hour training video. She lands, rents a car, uses her phone to navigate to the doctor's office and arrives 30 minutes early.

Battery/Platform Consumption

While waiting thirty minutes before the client meeting, Shannon starts her laptop for a final review of the client presentation. She has a calendar entry indicating the doctor's presentation is an hour meeting. The platform is using Shannon's preferred device settings for screen brightness while she is reviewing the material. After a few minutes, in this example, the platform determines that the battery is too low to complete the upcoming hour meeting. It therefore automatically lowers the screen brightness below Shannon's preference to conserve battery. After a few additional minutes the platform determines the battery will not last for the hour meeting. It may offer suggestions: 1. stop using the platform now, 2. charge the platform now for twenty-five minutes (while she continues to operate the device at the current workload), or 3. plug-in during the meeting. Shannon doesn't want to fumble around for an AC outlet during/before the upcoming meeting, so she decides to charge the platform while reviewing the content. Therefore, using calendar information and prior platform workload experience, the platform may predict its readiness for upcoming tasks. If future/predicted resource consumption is insufficient, the platform may provide recommendations to achieve the user's expected behavior. If current usage is also too demanding to achieve the future/predicted requirements, the platform may automatically adjust preferred user settings.

Meeting Adjourns and Return Trip

At the end of the meeting, Shannon sends an email to her manager that the presentation went well and the client is considering an order. Shannon sends another email to her husband with her estimated time of arrival back home. Shannon usually powers off the platform on the return flight. In this example, the platform doesn't prompt Shannon to recharge the battery. When Shannon closes the lid, the platform transitions to S4 (hibernate state). Therefore, the platform may intelligently (e.g., based on prior experience) only request/offer the user for support/remediation when appropriate. The platform may determine that it should save extra power at the cost of increasing the resume time and transition to S4 (hibernate state) instead of S3 (sleep state).

### Additional Notes and Examples

Example 1 may include a platform to self-manage resources, comprising a plurality of resources including one or more of a battery to supply power to the platform, a display to present information, a network controller to connect the platform to a wireless connectivity, a clock to provide timing information to the platform, an operating system to manage one or more settings of the platform or a memory to cache content. The platform may also include a user plan module to generate an activity plan for a user of the platform, a resource plan module to generate a resource plan based on the activity plan and a current state of the platform, and a remediation module to resolve one or more conflicts between the activity plan and the resource plan.

Example 2 may include the platform of Example 1, wherein the user plan module is to predict one or more of a meeting, a trip, a presentation, a media consumption session or an application usage to generate the activity plan.

Example 3 may include the platform of Example 1, wherein the activity plan is to be generated based on one or more of location information, calendar information, historical information or message information associated with the user.

Example 4 may include the platform of Example 1, wherein the resource plan module is to determine one or more resource needs of the platform and an availability of one or more of the plurality of resources to generate the resource plan.

Example 5 may include the platform of any one of Examples 1 to 4, wherein the remediation module is to one or more of automatically implement one or more platform changes or suggest one or more environmental changes to the user to resolve the one or more conflicts.

Example 6 may include the platform of Example 5, wherein the one or more platform changes are to include one or more of a charging configuration switch, a display brightness setting modification, a clock frequency setting modification, a wireless connectivity switch, an onscreen interruption setting modification, an update setting modification, a sleep state transition or a content caching setting modification.

Example 7 may include a method of managing platform resources, comprising generating an activity predication for a user of a platform, generating a resource plan based on the activity plan and a current state of the platform, and resolving one or more conflicts between the activity plan and the resource plan.

Example 8 may include the method of Example 7, wherein generating the activity plan includes predicting one or more of a meeting, a trip, a presentation, a media consumption session or an application usage.

Example 9 may include the method of Example 7, wherein the activity plan is generated based on one or more of location information, calendar information, historical information or message information associated with the user.

Example 10 may include the method of Example 7, wherein generating the resource plan includes determining one or more resource needs of the platform and an availability of one or more resources.

Example 11 may include the method of any one of Examples 7 to 10, wherein resolving the one or more conflicts includes one or more of automatically implementing one or more platform changes or suggesting one or more environmental changes to the user.

Example 12 may include the method of Example 11, wherein the one or more platform changes include one or more of a charging configuration switch, a display brightness setting modification, a clock frequency setting modification, a wireless connectivity switch, an onscreen interruption setting modification, an update setting modification, a sleep state transition or a content caching setting modification.

Example 13 may include at least one computer readable storage medium comprising a set of instructions which, if executed by a platform, cause the platform to generate an activity plan for a user of the platform, generate a resource plan based on the activity plan and a current state of the platform, and resolve one or more conflicts between the activity plan and the resource plan.

Example 14 may include the at least one computer readable storage medium of Example 13, wherein the instructions, if executed, cause the platform to predict one or more of a meeting, a trip, a presentation, a media consumption session or an application usage to generate the activity plan.

Example 15 may include the at least one computer readable storage medium of Example 13, wherein the activity plan is to be generated based on one or more of location information, calendar information, historical information or message information associated with the user.

Example 16 may include the at least one computer readable storage medium of Example 13, wherein the instructions, if executed, cause the platform to determine one or more resource needs of the platform and an availability of one or resources to generate the resource plan.

Example 17 may include the at least one computer readable storage medium of any one of Examples 13 to 16, wherein the instructions, if executed, cause the platform to one or more of automatically implement one or more platform changes or suggest one or more environmental changes to the user to resolve the one or more conflicts.

Example 18 may include the at least one computer readable storage medium of Example 17, wherein the one or more platform changes are to include one or more of a charging configuration switch, a display brightness setting modification, a clock frequency setting modification, a wireless connectivity switch, an onscreen interruption setting modification, an update setting modification, a sleep state transition or a content caching setting modification.

Example 19 may include an apparatus to manage platform resources, comprising one or more modules to determine a user's planned activities over a future timeframe and manage the platform resources to meet one or more needs associated with the user's planned activities.

Example 20 may include the apparatus of Example 19, wherein the one or more modules include a user plan module to generate an activity plan for the user, a resource plan module to generate a resource plan based on the activity plan and a current state of the platform, and a remediation module to resolve one or more conflicts between the activity plan and the resource plan.

Example 21 may include the apparatus of Example 20, wherein the user plan module is to predict one or more of a meeting, a trip, a presentation, a media consumption session or an application usage to generate the activity plan.

Example 22 may include the apparatus of Example 20, wherein the activity plan is to be generated based on one or more of location information, calendar information, historical information or message information associated with the user.

Example 23 may include the apparatus of Example 20, wherein the resource plan module is to determine one or more resource needs of the platform and an availability of one or more resources to generate the resource plan.

Example 24 may include the apparatus of any one of Examples 20 to 23, wherein the remediation module is to one or more of automatically implement one or more platform changes or suggest one or more environmental changes to the user to resolve the one or more conflicts.

Example 25 may include the apparatus of Example 24, wherein the one or more platform changes are to include one or more of a charging configuration switch, a display brightness setting modification, a clock frequency setting modification, a wireless connectivity switch, an onscreen interruption setting modification, an update setting modification, a sleep state transition or a content caching setting modification.

Example 26 may include an apparatus to manage platform resources, comprising means for performing the method of any one of Examples 7 to 12.

Thus, techniques described herein may obtain user context information, understand the user's goals and plans, determine device resources required to meet the user's goals and plans, take automatic action when such action can be accomplished without user impact, and proactively identify any conflicts between available resources and required resources. Such an approach may enable delivery of platforms that are “always connected” and exhibit significantly longer battery life. Moreover, platforms using the techniques described herein may eliminate any need for resource management and foresight on the part of end users. Simply put, users may spend more time and effort on tasks and activities of importance to them via the techniques described herein.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) evolve over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A platform to self-manage resources, comprising:
a plurality of resources including one or more of a battery to supply power to the platform, a display to present information, a network controller to connect the platform to a wireless network, a clock to provide timing information to the platform, an operating system to manage one or more settings of the platform or a memory to cache content;
a user plan module to generate an activity plan for a user of the platform;
a resource plan module to generate a resource plan based on the activity plan and a current state of the platform; and
a remediation module to resolve one or more conflicts between the activity plan and the resource plan.

2. The platform of claim 1, wherein the user plan module is to predict one or more of a meeting, a trip, a presentation, a media consumption session or an application usage to generate the activity plan.

3. The platform of claim 1, wherein the activity plan is to be generated based on one or more of location information, calendar information, historical information or message information associated with the user.

4. The platform of claim 1, wherein the resource plan module is to determine one or more resource needs of the platform and an availability of one or more of the plurality of resources to generate the resource plan.

5. The platform of claim 1, wherein the remediation module is to one or more of automatically implement one or more platform changes or suggest one or more environmental changes to the user to resolve the one or more conflicts.

6. The platform of claim 5, wherein the one or more platform changes are to include one or more of a charging configuration switch, a display brightness setting modification, a clock frequency setting modification, a wireless connectivity switch, an onscreen interruption setting modification, an update setting modification, a sleep state transition or a content caching setting modification.

7. A method of managing platform resources, comprising:
generating an activity plan for a user of a platform;
generating a resource plan based on the activity plan and a current state of the platform; and
resolving one or more conflicts between the activity plan and the resource plan.

8. The method of claim 7, wherein generating the activity plan includes predicting one or more of a meeting, a trip, a presentation, a media consumption session or an application usage.

9. The method of claim 7, wherein the activity plan is generated based on one or more of location information, calendar information, historical information or message information associated with the user.

10. The method of claim 7, wherein generating the resource plan includes determining one or more resource needs of the platform and an availability of one or more resources.

11. The method of claim 7, wherein resolving the one or more conflicts includes one or more of automatically implementing one or more platform changes or suggesting one or more environmental changes to the user.

12. The method of claim 11, wherein the one or more platform changes include one or more of a charging configuration switch, a display brightness setting modification, a clock frequency setting modification, a wireless connectivity switch, an onscreen interruption setting modification, an update setting modification, a sleep state transition or a content caching setting modification.

13. At least one computer readable storage medium comprising a set of instructions which, if executed by a platform, cause the platform to:
generate an activity plan for a user of a platform;
generate a resource plan based on the activity plan and a current state of the platform; and
resolve one or more conflicts between the activity plan and the resource plan.

14. The at least one computer readable storage medium of claim 13, wherein the instructions, if executed, cause the platform to predict one or more of a meeting, a trip, a presentation, a media consumption session or an application usage to generate the activity plan.

15. The at least one computer readable storage medium of claim 13, wherein the activity plan is to be generated based on one or more of location information, calendar information, historical information or message information associated with the user.

16. The at least one computer readable storage medium of claim 13, wherein the instructions, if executed, cause the platform to determine one or more resource needs of the platform and an availability of one or resources to generate the resource plan.

17. The at least one computer readable storage medium of claim 13, wherein the instructions, if executed, cause the platform to one or more of automatically implement one or more platform changes or suggest one or more environmental changes to the user to resolve the one or more conflicts.

18. The at least one computer readable storage medium of claim 17, wherein the one or more platform changes are to include one or more of a charging configuration switch, a display brightness setting modification, a clock frequency setting modification, a wireless connectivity switch, an onscreen interruption setting modification, an update setting modification, a sleep state transition or a content caching setting modification.

19. An apparatus to manage platform resources, comprising:
one or more modules to determine a user's planned activities over a future timeframe and manage the platform resources to meet one or more needs associated with the user's planned activities.

20. The apparatus of claim 19, wherein the one or more modules include:
a user plan module to generate an activity plan for the user;
a resource plan module to generate a resource plan based on the activity plan and a current state of the platform; and
a remediation module to resolve one or more conflicts between the activity plan and the resource plan.

21. The apparatus of claim 20, wherein the user plan module is to predict one or more of a meeting, a trip, a presentation, a media consumption session or an application usage to generate the activity plan.

22. The apparatus of claim 20, wherein the activity plan is to be generated based on one or more of location information, calendar information, historical information or message information associated with the user.

23. The apparatus of claim 20, wherein the resource plan module is to determine one or more resource needs of the platform and an availability of one or more resources to generate the resource plan.

24. The apparatus of claim 20, wherein the remediation module is to one or more of automatically implement one or more platform changes or suggest one or more environmental changes to the user to resolve the one or more conflicts.

25. The apparatus of claim 24, wherein the one or more platform changes are to include one or more of a charging configuration switch, a display brightness setting modification, a clock frequency setting modification, a wireless connectivity switch, an onscreen interruption setting modification, an update setting modification, a sleep state transition or a content caching setting modification.
